(19) United States
(12) Patent Application Publication
(10) Pub. No.: US 2026/0168447 A1
(43) Pub. Date: Jun. 18, 2026

(54) CONTROL DEVICE FOR INTERNAL COMBUSTION ENGINE, CONTROL METHOD FOR INTERNAL COMBUSTION ENGINE, AND STORAGE MEDIUM

(71) Applicant: HONDA MOTOR CO., LTD., TOKYO (JP)

(72) Inventors: Taijiro KAWAMURA, TOKYO (JP); Ryuichi HATA, TOKYO (JP); Hiroaki TONE, TOKYO (JP); Takeshi KONO, TOKYO (JP); Toshifumi KONDO, TOKYO (JP); Yujiro TSUTSUMI, TOKYO (JP); Kazushi KIKUCHI, TOKYO (JP)

(21) Appl. No.: 19/418,199

(22) Filed: Dec. 12, 2025

(30) Foreign Application Priority Data
Dec. 17, 2024 (JP) 2024-220975

(51) Int. Cl. F02D 9/02; F02D 41/00; F02D 41/02; F02D 41/14; F02D 41/18

(52) U.S. Cl. CPC F02D 9/02; F02D 41/0002; F02D 41/0235; F02D 41/1446; F02D 41/18; F02D 2009/0222; F02D 2041/0265; F02D 2200/04

(57) ABSTRACT

In a control device for an internal combustion engine, in the case that an intake air amount is calculated based on a flow rate signal, there is carried out a catalyst protection control based on an acquired exhaust gas temperature and a first predetermined temperature, and in the case that an intake air amount is calculated based on a pressure signal, there is carried out the catalyst protection control based on the acquired exhaust gas temperature and a second predetermined temperature that differs from the first predetermined temperature.

### CROSS-REFERENCE TO RELATED APPLICATIONS

This application is based upon and claims the benefit of priority from Japanese Patent Application No. 2024-220975 filed on Dec. 17, 2024, the contents of which are incorporated herein by reference.

### BACKGROUND OF THE INVENTION

### Field of the Invention

The present disclosure relates to a control device for an internal combustion engine, a control method for an internal combustion engine, and a storage medium.

### Description of the Related Art

In JP 2020-012387 A, an engine control device is disclosed. In the case that it is determined that an intake pulsation is not large, an intake amount is calculated by the engine control device based on an intake flow rate detected by an air flow meter. Further, in the case that it is determined that an intake pulsation is large, the intake amount is calculated by the engine control device based on an intake pipe pressure.

### SUMMARY OF THE INVENTION

Efforts have been ongoing with the aim of alleviating or reducing the impact of climate change, and research and development into exhaust gas purification devices has been carried out in order to achieve this goal.

Incidentally, in the field of exhaust purification devices, there is a demand for a more satisfactory internal combustion engine control device, a more satisfactory internal combustion engine control method, a program that causes a computer to execute a more satisfactory internal combustion engine control method, and a storage medium that stores a program that causes a computer to execute a more satisfactory internal combustion engine control method. The present disclosure, in order to solve the aforementioned problem, has the object of providing a more satisfactory internal combustion engine control device, a more satisfactory internal combustion engine control method, a program that causes a computer to execute a more satisfactory internal combustion engine control method, and a storage medium that stores a program that causes a computer to execute a more satisfactory internal combustion engine control method. In addition, the present disclosure contributes to mitigating or reducing the impact of climate change.

A first aspect of the present invention is characterized by a control device for an internal combustion engine, including a flow rate signal acquisition unit configured to acquire from an air flow meter a flow rate signal that changes in accordance with an air flow rate inside an intake pipe of the internal combustion engine, a pressure signal acquisition unit configured to acquire from a pressure sensor a pressure signal that changes in accordance with a pressure inside the intake pipe, an intake air amount calculation unit configured to calculate, based on the flow rate signal or the pressure signal, an intake air amount, which is an amount of air taken in by the internal combustion engine, an exhaust temperature acquisition unit configured to acquire an exhaust temperature of the internal combustion engine, and a control unit which, by adjusting a throttle valve degree of opening, carries out a catalyst protection control to limit the intake air amount in order to protect a catalyst, wherein, in the case that the intake air amount is calculated based on the flow rate signal, the control unit carries out the catalyst protection control based on the acquired exhaust temperature and a first predetermined temperature, and in the case that the intake air amount is calculated based on the pressure signal, the control unit carries out the catalyst protection control based on the acquired exhaust temperature and a second predetermined temperature that differs from the first predetermined temperature.

A second aspect of the present invention is characterized by a control method for an internal combustion engine, including a signal acquisition step of acquiring from an air flow meter a flow rate signal that changes in accordance with an air flow rate inside an intake pipe of the internal combustion engine, or alternatively, acquiring from a pressure sensor a pressure signal that changes in accordance with a pressure inside the intake pipe, an intake air amount calculation step of calculating, based on the flow rate signal or the pressure signal, an intake air amount, which is an amount of air taken in by the internal combustion engine, an exhaust temperature acquisition step of acquiring an exhaust temperature of the internal combustion engine, and a control step of carrying out a catalyst protection control to limit the intake air amount in order to protect the catalyst by adjusting a throttle valve degree of opening, wherein, in the case that the intake air amount is calculated based on the flow rate signal, the catalyst protection control is carried out based on an acquired exhaust temperature and a first predetermined temperature, and in the case that the intake air amount is calculated based on the pressure signal, the catalyst protection control is carried out based on the acquired exhaust temperature and a second predetermined temperature that differs from the first predetermined temperature.

A third aspect of the present disclosure is characterized by a program that causes a computer to execute the control method for the internal combustion engine according to the second aspect.

A fourth aspect of the present disclosure is characterized by a computer readable non-transitory storage medium in which the program according to the third aspect is stored.

According to the present disclosure, it is possible to provide a more satisfactory internal combustion engine control device, a more satisfactory internal combustion engine control method, a program that causes a computer to execute a more satisfactory internal combustion engine control method, and a storage medium that stores a program that causes a computer to execute a more satisfactory internal combustion engine control method.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic diagram of an internal combustion engine and an intake and exhaust system according to a first embodiment;

FIG. 2 is a block diagram showing a configuration of a control device according to the first embodiment;

FIG. 3 is a map showing a flow rate signal region and a pressure signal region in the calculation of an intake air amount according to the first embodiment;

FIG. 4 is a flowchart of a throttle valve degree of opening control according to the first embodiment;

FIG. 5 is a graph showing a change over time in an accelerator pedal degree of opening, a change in an exhaust temperature, a change in an air-fuel ratio (λ), and a change in an intake air amount;

FIG. 6 is a graph showing the change over time in the accelerator pedal degree of opening, the change in the exhaust temperature, the change in the air-fuel ratio (λ), and the change in the intake air amount;

FIG. 7 is a graph showing the change over time in the accelerator pedal degree of opening, the change in the exhaust temperature, the change in the air-fuel ratio (λ), and the change in the intake air amount;

FIG. 8 is a graph showing a relationship between a throttle valve degree of opening and an output torque of the internal combustion engine according to a second embodiment;

FIG. 9 is a map of a target throttle valve degree of opening with respect to a required degree of opening according to the second embodiment;

FIG. 10 is a map showing a flow rate signal region and a pressure signal region according to the second embodiment; and

FIG. 11 is a flowchart of the throttle valve degree of opening control according to the second embodiment.

### DETAILED DESCRIPTION OF THE INVENTION

In many gasoline vehicles, a control (hereinafter referred to as a rich control) is carried out to bring about a state in which an air-fuel ratio of the air-fuel mixture is more fuel-rich (λ is approximately 0.8) than a theoretical air-fuel ratio (a stoichiometric ratio, λ=1) when operating at a high load. Heat is removed by vaporizing the fuel inside the cylinders of an internal combustion engine, and while maintaining a high output, the temperature of the exhaust gas (hereinafter referred to as an exhaust temperature) is prevented from exceeding a heat resistance temperature of a catalyst or the like.

However, with the rich control, a problem is brought about in that the amount of the exhaust gas increases due to a large amount of fuel being injected. Further, with the rich control, a problem is brought about in that, since the air-fuel ratio deviates from the stoichiometric ratio, the oxidation reduction efficiency of a three-way catalyst decreases. Therefore, from the viewpoint of cleaning the exhaust gas, even during a high load operation, it is necessary to operate the engine at the stoichiometric ratio.

As a control (hereinafter, referred to as a catalyst protection control) for suppressing the exhaust temperature and thereby protecting the catalyst or the like, there is a control (hereinafter, referred to as an air amount limiting control) in which, by narrowing a throttle valve degree of opening, the amount of air (hereinafter, referred to as an air intake amount) that is taken into the internal combustion engine is restricted. However, in the case that the stoichiometric ratio is maintained, since the fuel injection amount is also limited accompanying the restriction of the intake air amount by the air amount limiting control, the output of the internal combustion engine is restricted.

It is desired to shorten the period during which the air amount limiting control is carried out as the catalyst protection control, and to shorten the period during which the output of the internal combustion engine is restricted. Further, there is a demand to reduce the operating range in which the output of the internal combustion engine is restricted.

According to the present disclosure, while carrying out the air amount limiting control as the exhaust temperature suppression control, it is possible to shorten the period during which the output of the internal combustion engine is restricted. Further, it is possible to reduce the operating range in which the output of the internal combustion engine is restricted.

A description will be given below with reference to the accompanying drawings concerning a control device for an internal combustion engine, a control method for an internal combustion engine, a program, a program, and a storage medium according to a first embodiment and a second embodiment.

The program (a computer program, computer software) according to the first embodiment and the second embodiment may also be referred to as a computer program product. The computer program product is not limited to being a computer program that is recorded on a recording medium, but may also include a computer program that is transmitted, distributed, or downloaded via the Internet or the like.

### First Embodiment

### [Internal Combustion Engine and Intake and Exhaust System]

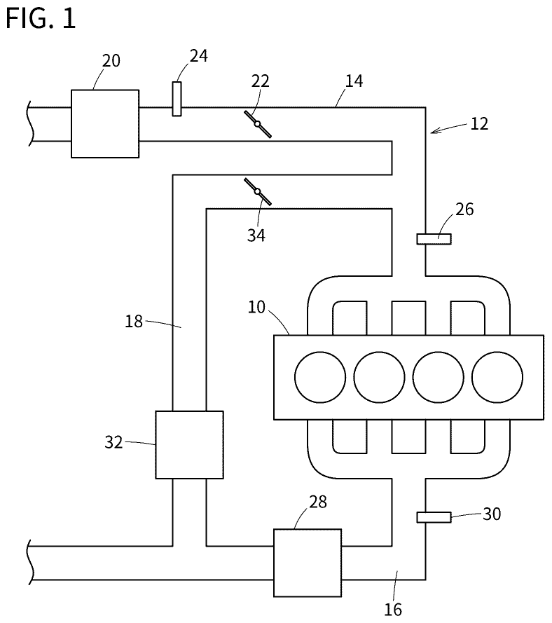

FIG. 1 is a schematic diagram of an internal combustion engine 10 and an intake and exhaust system 12 according to a first embodiment.

The internal combustion engine 10 is a gasoline engine. The intake and exhaust system 12 is equipped with an intake pipe 14 that draws in air, an exhaust pipe 16 that discharges an exhaust gas from the internal combustion engine 10, and an exhaust gas recirculation (hereinafter referred to as an EGR) pipe 18 that serves to return the exhaust gas to the intake pipe 14.

An air filter 20, a throttle valve 22, an air flow meter 24, and a pressure sensor 26 are disposed in the intake pipe 14. The air filter 20 filters the air that is drawn in, and thereby removes dust, dirt, and the like that are contained in the air. The throttle valve 22, depending on a degree of opening required by the driver, adjusts the amount of air (hereinafter referred to as an intake air amount) that is drawn into the intake pipe 14. The air flow meter 24 is disposed between the air filter 20 and the throttle valve 22. Further, the air flow meter 24 is disposed more upstream (on the air filter 20 side) than a connection location of the EGR pipe 18 with respect to the intake pipe 14. The air flow meter 24 outputs a flow rate signal that changes in accordance with the air flow rate inside the intake pipe 14. The pressure sensor 26 is disposed more downstream (on the internal combustion engine 10 side) of the connection location of the EGR pipe 18 to the intake pipe 14. The pressure sensor 26 outputs a pressure signal that changes in accordance with the pressure inside the intake pipe 14.

A catalyst 28 and a temperature sensor 30 are disposed in the exhaust pipe 16. The catalyst 28, for example, is a three-way catalyst. The catalyst 28 oxidizes or reduces hydrocarbons (HC), carbon monoxide (CO), nitrogen oxides (NOx), and the like that are contained within the exhaust gas, thereby causing them to be converted into water, carbon dioxide, nitrogen, oxygen, and the like. The temperature sensor 30 detects the temperature (hereinafter, referred to as an exhaust temperature) of the exhaust gas. The temperature sensor 30 is disposed more upstream (on the internal combustion engine 10 side) than the catalyst 28.

An EGR cooler 32 and an EGR valve 34 are disposed in the EGR pipe 18. The EGR cooler 32 serves to cool the exhaust gas that is returned to the intake pipe 14. The EGR valve 34, by changing the degree of opening thereof, adjusts the amount of the exhaust gas that is returned to the intake pipe 14.

### [Control Device]

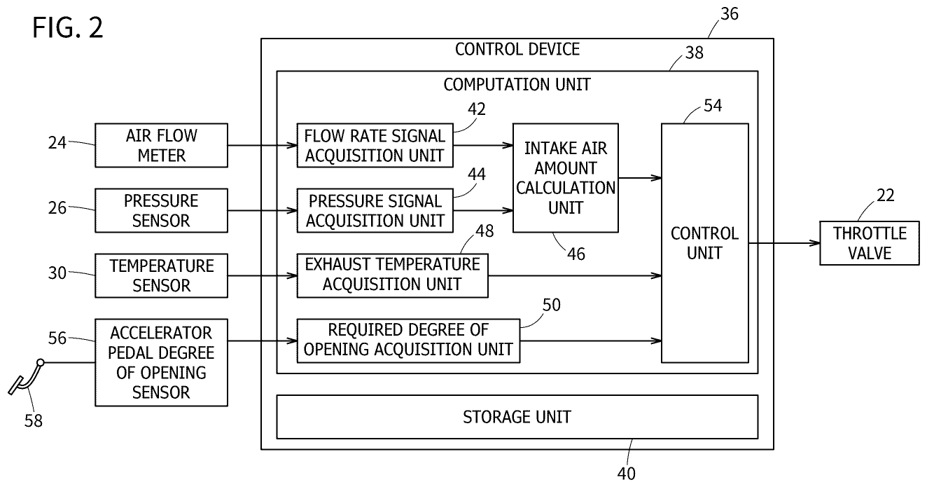

FIG. 2 is a block diagram showing a configuration of a control device 36 according to the first embodiment.

The control device 36 includes a computation unit 38 and a storage unit 40. The computation unit 38, for example, is a processor such as a CPU (Central Processing Unit) or a GPU (Graphics Processing Unit) or the like. The computation unit 38 includes a flow rate signal acquisition unit 42, a pressure signal acquisition unit 44, an intake air amount calculation unit 46, an exhaust temperature acquisition unit 48, a required degree of opening acquisition unit 50, and a control unit 54. The flow rate signal acquisition unit 42, the pressure signal acquisition unit 44, the intake air amount calculation unit 46, the exhaust temperature acquisition unit 48, the required degree of opening acquisition unit 50, and the control unit 54 are realized by executing in the computation unit 38 a program that is stored in the storage unit 40. At least a portion of the flow rate signal acquisition unit 42, the pressure signal acquisition unit 44, the intake air amount calculation unit 46, the exhaust temperature acquisition unit 48, the required degree of opening acquisition unit 50, and the control unit 54 may be realized by an integrated circuit such as an ASIC (Application Specific Integrated Circuit) or an FPGA (Field-Programmable Gate Array) or the like. At least a portion of the flow rate signal acquisition unit 42, the pressure signal acquisition unit 44, the intake air amount calculation unit 46, the exhaust temperature acquisition unit 48, the required degree of opening acquisition unit 50, and the control unit 54 may be realized by an electronic circuit including a discrete device.

The storage unit 40 is a computer readable non-transitory tangible storage medium. The storage unit 40 is constituted by a non-illustrated volatile memory, and a non-illustrated non-volatile memory. The volatile memory, for example, is a RAM (Random Access Memory) or the like. The non-volatile memory, for example, is a ROM (Read Only Memory) or a flash memory or the like. Data and the like are stored, for example, in the volatile memory. A program, a table, a map, and the like are stored, for example, in the non-volatile memory. At least a portion of the storage unit 40 may be provided in the aforementioned processor, the integrated circuit, or the like. At least a portion of the storage unit 40 may be installed in a device that is connected with the control device 36 by means of a network.

The flow rate signal acquisition unit 42 acquires a flow rate signal from the air flow meter 24. The pressure signal acquisition unit 44 acquires a pressure signal from the pressure sensor 26. The intake air amount calculation unit 46, based on the flow rate signal or the pressure signal, calculates the intake air amount. The exhaust temperature acquisition unit 48 acquires the exhaust temperature that is detected by the temperature sensor 30. The exhaust temperature acquisition unit 48 may acquire an exhaust temperature which is estimated from a parameter related to the exhaust temperature. As such a parameter related to the exhaust temperature, there may be cited a rotational speed of the internal combustion engine 10, an amount of intake air of the internal combustion engine 10, a temperature of the cooling water of the internal combustion engine 10, or the like. The required degree of opening acquisition unit 50 obtains a degree of opening of an accelerator pedal 58 that is detected by an accelerator pedal degree of opening sensor 56. The required degree of opening acquisition unit 50, based on the degree of opening of the accelerator pedal 58, obtains a required degree of opening, which is a required value of the throttle valve degree of opening. The control unit 54 controls the throttle valve 22, and thereby adjusts the throttle valve degree of opening. Specifically, the act of controlling the throttle valve 22 signifies controlling a drive motor (not shown) that causes the throttle valve 22 to open and close. The control unit 54, based on the intake air amount and the required degree of opening, controls the throttle valve 22.

### [Concerning Calculation of Intake Air Amount]

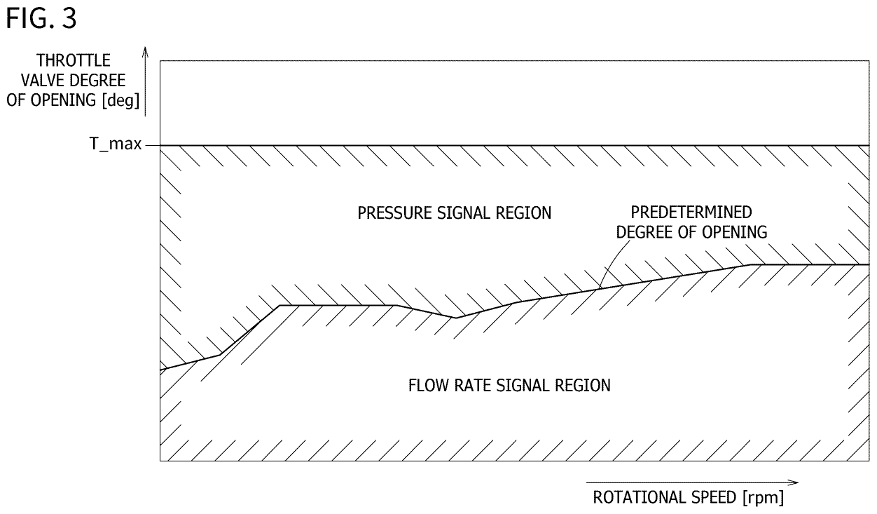

FIG. 3 is a map showing a flow rate signal region and a pressure signal region according to the first embodiment. The flow rate signal region defines a region in which the intake air amount calculation unit 46 calculates the intake air amount based on the flow rate signal. The pressure signal region defines a region in which the intake air amount calculation unit 46 calculates the intake air amount based on the pressure signal. In FIG. 3, T_max [deg] indicates a degree of opening when the throttle valve is fully open. T_max [deg] is approximately 80 [deg].

In order to maintain the stoichiometric ratio, a fuel injection amount is determined in accordance with the intake air amount, in a manner so that a weight ratio of the air to the fuel in the air-fuel mixture becomes 14.7:1. Therefore, it is necessary to determine the intake air amount with high accuracy.

The air flow meter 24 is equipped with a temperature sensitive resistor element. The temperature sensitive resistor element is heated by a heater to a constant temperature. Further, a constant electrical current flows through the temperature sensitive resistor element. By the temperature sensitive resistor element being exposed to air that flows therein, the resistance thereof changes, and the voltage that is applied to the temperature sensitive resistor element changes. The air flow meter 24 outputs as a flow rate signal a voltage signal that changes in accordance with the intake air amount. The air flow meter 24 may output as the flow rate signal a frequency signal obtained by having converted the voltage signal into a digital signal. Since the change in the voltage becomes larger as the intake air amount is greater, the voltage applied to the temperature sensitive resistor element can be converted into the intake air amount. Stated otherwise, the intake air amount can be calculated directly from the flow rate signal.

The pressure sensor 26 is equipped with a diaphragm in which a strain gauge is provided. A constant current is flowing through the strain gauge. By the diaphragm being deformed due to the air pressure, the resistance of the strain gauge changes, and the voltage applied to the strain gauge changes. The pressure sensor 26 outputs as a pressure signal the voltage signal that changes in accordance with the intake air pressure. The pressure sensor 26 may output as the pressure signal a frequency signal obtained by having converted the voltage signal into a digital signal. Since the change in the voltage becomes larger as the intake air pressure is higher, the voltage being applied to the strain gauge can be converted into the intake air pressure. The intake air amount is calculated from the intake air pressure that is obtained from the pressure signal.

As noted previously, in contrast to the intake air amount being calculated directly from the flow rate signal, the intake air amount is calculated indirectly from the pressure signal. Therefore, the intake air amount that is calculated based on the flow rate signal has a higher ability to follow along with respect to changes in the actual air flow rate than the intake air amount that is calculated based on the pressure signal.

In each of the cylinders of the internal combustion engine 10, due to the opening and closing of the intake valve, a blowby gas return, and the like, pulsations occur inside the intake pipe 14. At a time when the internal combustion engine 10 is operating at a medium to low load, the throttle valve degree of opening is comparatively small, and the pulsations are comparatively small. However, at a time when the internal combustion engine 10 is operating under a high load, the throttle valve degree of opening is comparatively large, and the pulsations increase. The air flow meter 24, due to the structure thereof, exhibits a low sensitivity with respect to a backflow component of the air flow rate, and in an operating region in which the pulsations are relatively large, the accuracy of the intake air amount that is calculated based on the flow rate signal decreases.

In a region in which the throttle valve degree of opening is comparatively large, with respect to the change in the throttle valve degree of opening, the change in the intake air amount is small. Therefore, at a time when the internal combustion engine 10 is operating under a high load, the accuracy of the intake air amount that is calculated based on the pressure signal is comparatively high in comparison with the accuracy of the intake air amount that is calculated based on the flow rate signal.

According to the first embodiment, at a time when the throttle valve degree of opening is less than a predetermined degree of opening and the internal combustion engine 10 is operating under a medium to low load, the intake air amount calculation unit 46 calculates the intake air amount based on the flow rate signal. On the other hand, at a time when the throttle valve degree of opening is greater than or equal to the predetermined degree of opening and the internal combustion engine 10 is operating under a high load, the intake air amount calculation unit 46 calculates the intake air amount based on the pressure signal. The predetermined degree of opening, as shown in FIG. 3, is set in accordance with the rotational speed of the internal combustion engine 10.

### [Concerning the Catalyst Protection Control]

According to the first embodiment, the air amount limiting control is carried out as the catalyst protection control. Due to the air amount limiting control being carried out, the exhaust temperature is prevented from exceeding the heat resistance temperature of the catalyst or the like.

In the air amount limiting control, the intake air amount is limited in a manner so that the exhaust temperature falls below a first predetermined temperature or a second predetermined temperature. The control unit 54 controls the throttle valve 22 in accordance with the intake air amount that is calculated by the intake air amount calculation unit 46.

Since the intake air amount that is calculated by the intake air amount calculation unit 46 includes an error therein, the first predetermined temperature and the second predetermined temperature are set to temperatures that are lower than the heat resistant temperature. As noted previously, at a time when the internal combustion engine 10 is operating under a high load, the accuracy of the intake air amount that is calculated based on the pressure signal is comparatively high in comparison with the accuracy of the intake air amount that is calculated based on the flow rate signal. Therefore, the second predetermined temperature is set to a temperature that is higher than the first predetermined temperature. In accordance with this feature, the difference between the heat resistance temperature and the second predetermined temperature is smaller than the difference between the heat resistance temperature and the first predetermined temperature.

Within the flow rate signal region, the catalyst protection control is carried out based on the exhaust temperature having reached the first predetermined temperature, and in the pressure signal region, the catalyst protection control is carried out based on the exhaust temperature having reached the second predetermined temperature that is higher than the first predetermined temperature. Stated otherwise, within the flow rate signal region, the catalyst protection control is not carried out until the exhaust temperature reaches the first predetermined temperature, and in the pressure signal region, the catalyst protection control is not carried out until the exhaust temperature reaches the second predetermined temperature that is higher than the first predetermined temperature. Since the pressure signal region is reached at the time when the internal combustion engine 10 is operating under a high load, in a situation in which the driver requires a high output, a decrease in the output of the internal combustion engine 10 can be suppressed.

Within the flow rate signal region, the catalyst protection control may be carried out prior to the exhaust temperature reaching the first predetermined temperature, in a manner so that the exhaust temperature does not reach the first predetermined temperature. Further, within the pressure signal region, the catalyst protection control may be carried out prior to the exhaust temperature reaching the second predetermined temperature, in a manner so that the exhaust temperature does not reach the second predetermined temperature.

### [Throttle Valve Degree of Opening Control]

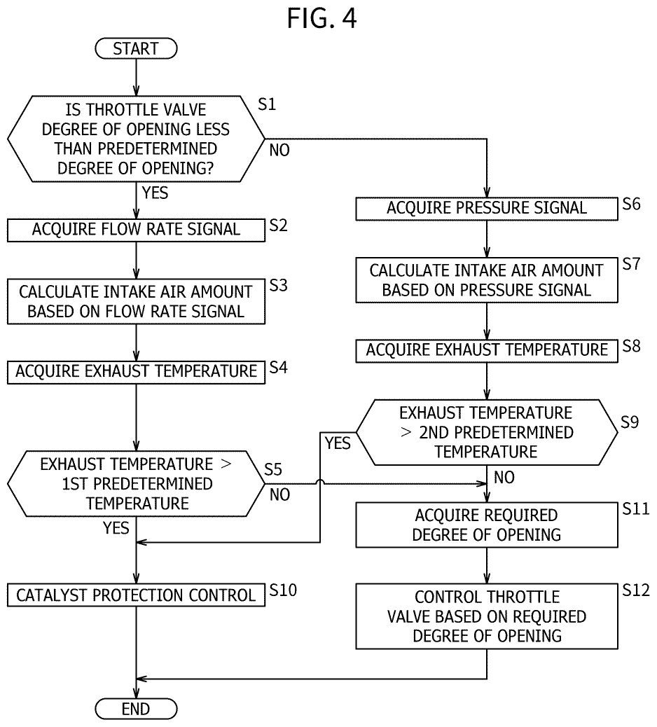

FIG. 4 is a flowchart of the throttle valve degree of opening control according to the first embodiment. In the control device 36, the throttle valve degree of opening control is executed at predetermined intervals while the internal combustion engine 10 is being driven.

In step S1, the intake air amount calculation unit 46 determines whether or not the throttle valve degree of opening is less than the predetermined degree of opening. In the case that it is determined that the throttle valve degree of opening is less than the predetermined degree of opening (step S1: YES), the process transitions to step S2.

In step S2, the flow rate signal acquisition unit 42 acquires the flow rate signal from the air flow meter 24. Thereafter, the process transitions to step S3.

In step S3, the intake air amount calculation unit 46 calculates the intake air amount based on the flow rate signal. Thereafter, the process transitions to step S4.

In step S4, the exhaust temperature acquisition unit 48 acquires the exhaust temperature. Thereafter, the process transitions to step S5.

In step S5, the control unit 54 determines whether or not the exhaust temperature is higher than the first predetermined temperature.

In step S1, in the case that it is determined that the throttle valve degree of opening is greater than or equal to the predetermined degree of opening (step S1: NO), the process transitions to step S6.

In step S6, the pressure signal acquisition unit 44 acquires a pressure signal from the pressure sensor 26. Thereafter, the process transitions to step S7.

In step S7, the intake air amount calculation unit 46 calculates the intake air amount based on the pressure signal. Thereafter, the process transitions to step S8.

In step S8, the exhaust temperature acquisition unit 48 acquires the exhaust temperature from the temperature sensor 30. Thereafter, the process transitions to step S9.

In step S9, the control unit 54 determines whether or not the exhaust temperature is higher than the second predetermined temperature.

In step S5, in the case that it is determined that the exhaust temperature is higher than the first predetermined temperature (step S5: YES), or alternatively, in step S9, in the case that it is determined that the exhaust temperature is higher than the second predetermined temperature (step S9: YES), the process transitions to step S10.

In step S10, the control unit 54 carries out the catalyst protection control. The catalyst protection control indicates the aforementioned air amount limiting control.

In step S5, in the case that it is determined that the exhaust temperature is less than or equal to the first predetermined temperature (step S5: NO), or alternatively, in step S9, in the case that it is determined that the exhaust temperature is less than or equal to the second predetermined temperature (step S9: NO), the process transitions to step S11.

In step S11, a required degree of opening calculation unit 52 acquires the required degree of opening. Thereafter, the process transitions to step S12.

In step S12, the control unit 54 controls the throttle valve 22 based on the required degree of opening.

### [Operations and Advantageous Effects]

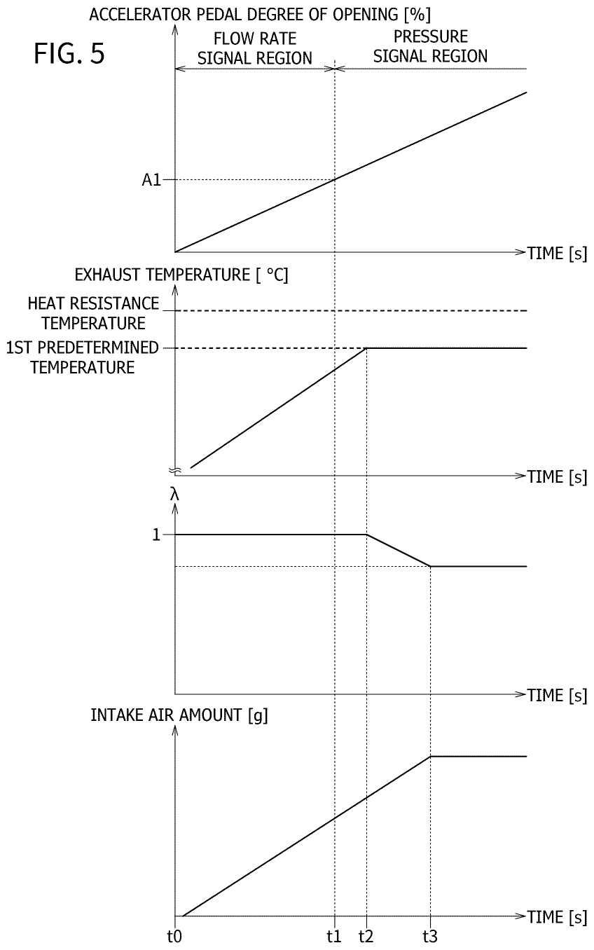

FIG. 5 to FIG. 7 are graphs showing a change over time in an accelerator pedal degree of opening, a change in an exhaust temperature, a change in an air-fuel ratio (λ), and a change in an intake air amount. In a time range indicated on the horizontal axis of FIG. 5 to FIG. 7, the rotational speed of the internal combustion engine 10 is constant. In the graphs of FIG. 5 to FIG. 7, a change in an exhaust temperature, a change in an air-fuel ratio (λ), and a change in an intake air amount are shown schematically.

In a range from time t0 to time t1, the accelerator pedal degree of opening is less than A1 [%], and at this time, the throttle valve degree of opening is less than the predetermined degree of opening. In a range from time t0 to time t1, the intake air amount calculation unit 46 calculates the intake air amount based on the flow rate signal (the flow rate signal region). Further, in a range after time t1, the accelerator pedal degree of opening becomes greater than or equal to A1 [%], and at this time, the throttle valve degree of opening becomes greater than or equal to the predetermined degree of opening. In a range after time t1, the intake air amount calculation unit 46 calculates the intake air amount based on the pressure signal (the pressure signal region).

The graph of FIG. 5 shows a change in an accelerator pedal degree of opening, a change in an exhaust temperature, a change in an air-fuel ratio (λ), and a change in an intake air amount, in the case that a catalyst protection control according to a first comparative example is carried out.

In the catalyst protection control according to the first comparative example, the rich control and the air amount limiting control are carried out. In the catalyst protection control according to the first comparative example, regardless of whether it is the flow rate signal region or the pressure signal region, the rich control is initiated based on the exhaust gas temperature having reached the first predetermined temperature. In the example shown in FIG. 5, in the pressure signal region, the rich control is initiated at time t2 [s] when the exhaust temperature has reached the first predetermined temperature. In the rich control, the air-fuel ratio is adjusted within a range from λ=1 to, for example, λ=0.8, in a manner so that the exhaust temperature does not exceed the first predetermined temperature. At time t3 when the air-fuel ratio has reached λ=0.8, the air amount limiting control is initiated.

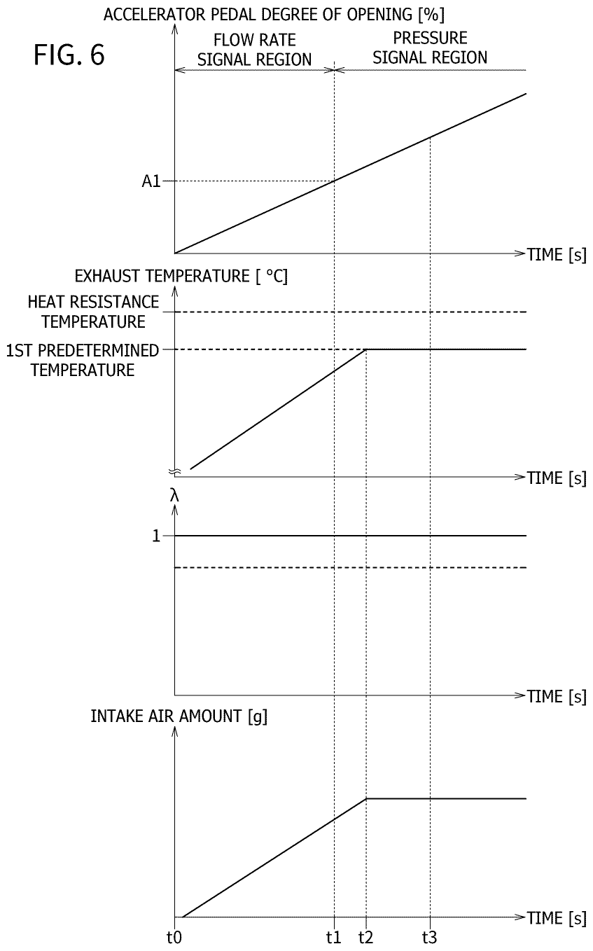

The graph of FIG. 6 shows a change in an accelerator pedal degree of opening, a change in an exhaust temperature, a change in an air-fuel ratio (λ), and a change in an intake air amount, in the case that a catalyst protection control according to a second comparative example is carried out.

In the catalyst protection control according to the second comparative example, only the air amount limiting control is carried out. In the catalyst protection control according to the first comparative example, regardless of whether it is the flow rate signal region or the pressure signal region, the air amount limiting control is initiated based on the exhaust gas temperature having reached the first predetermined temperature. In the example shown in FIG. 6, in the pressure signal region, the air amount limiting control is initiated at time t2 [s] when the exhaust temperature has reached the first predetermined temperature.

In the first comparative example, the air amount limiting control is started at time t3. On the other hand, in the second comparative example, the air amount limiting control is started at time t2 which is earlier than time t3. Therefore, in the second comparative example, the period during which the air amount limiting control is carried out is longer in comparison with the first comparative example, and the period during which the output of the internal combustion engine 10 is restricted is made longer.

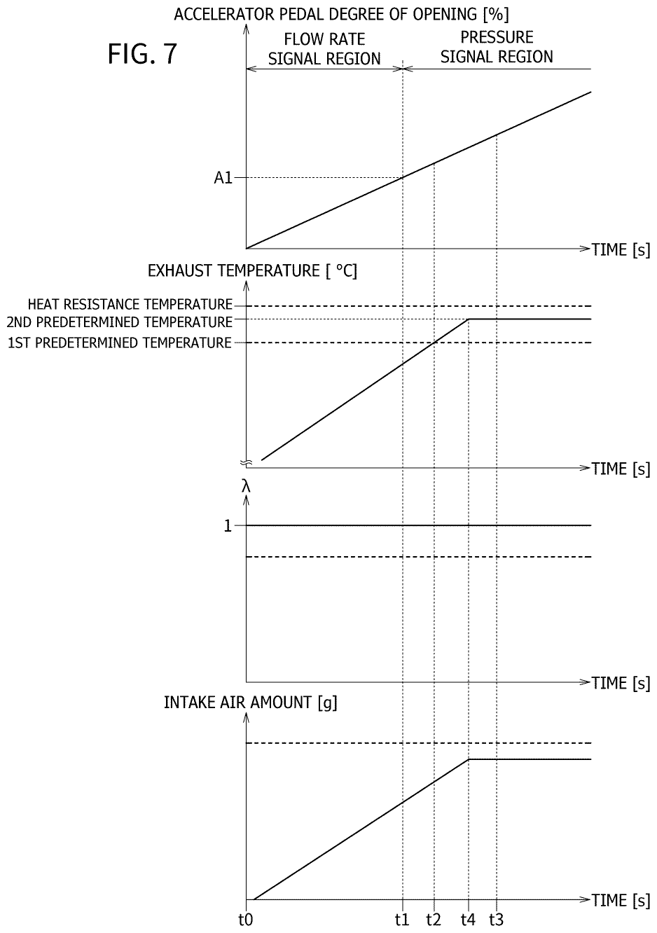

The graph of FIG. 7 shows a change in an accelerator pedal degree of opening, a change in an exhaust temperature, a change in an air-fuel ratio (λ), and a change in an intake air amount, in the case that a catalyst protection control according to the first embodiment is carried out.

In the catalyst protection control according to the first embodiment, only the air amount limiting control is carried out. In the catalyst protection control according to the first embodiment, in the case that the flow rate signal region is selected, the air amount limiting control is initiated based on the exhaust temperature having reached the first predetermined temperature, and in the case that the pressure signal region is selected, the air amount limiting control is initiated based on the exhaust temperature having reached the second predetermined temperature. In the example shown in FIG. 7, in the pressure signal region, the air amount limiting control is initiated at time t4 [s] when the exhaust temperature has reached the second predetermined temperature.

In the second comparative example, the air amount limiting control is started at time t2. On the other hand, in the first embodiment, the air amount limiting control is started at time t4 which is later than time t2. Therefore, in the first embodiment, the period during which the air amount limiting control is carried out can be made shorter in comparison with the second comparative example, and the period during which the output of the internal combustion engine 10 is restricted can be made shorter. Further, it is possible to reduce the operating range in which the output of the internal combustion engine 10 is restricted.

### Second Embodiment

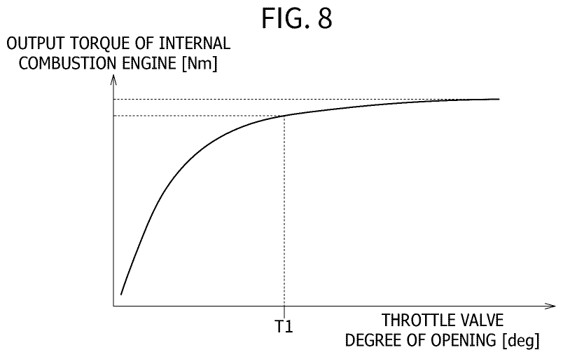

FIG. 8 is a graph showing a relationship between a throttle valve degree of opening and the output torque of the internal combustion engine 10 according to a second embodiment. As shown in FIG. 8, as the throttle valve degree of opening becomes larger, the amount of change in the output torque becomes smaller. In a range in which the throttle valve degree of opening is greater than or equal to T1 [deg], the output torque does not change substantially with respect to changes in the throttle valve degree of opening.

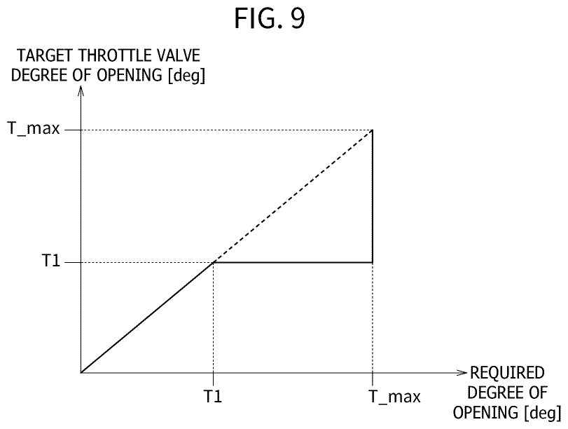

FIG. 9 is a map of a target throttle valve degree of opening with respect to a required degree of opening according to the second embodiment. In a range in which the throttle valve degree of opening is greater than or equal to T1 [deg], the response of the output torque with respect to the throttle valve degree of opening is small, and it is difficult to control the output torque by means of the throttle valve degree of opening. In the second embodiment, in the case that the required degree of opening that is calculated based on the accelerator pedal degree of opening is greater than or equal to T1 [deg], and further, is less than T_max [deg], the target throttle valve degree of opening is set to T1 [deg]. Further, in the case that the required degree of opening is T_max [deg], the target throttle valve degree of opening is set to T_max [deg]. The degree of opening T_max [deg] indicates that the throttle valve degree of opening is fully open.

Moreover, in a hybrid vehicle, even in the case that the vehicle is driven by both the output torque of the internal combustion engine and the output torque of the drive motor, the relationship between the throttle valve degree of opening and the output torque of the internal combustion engine is the same as the relationship shown in FIG. 8.

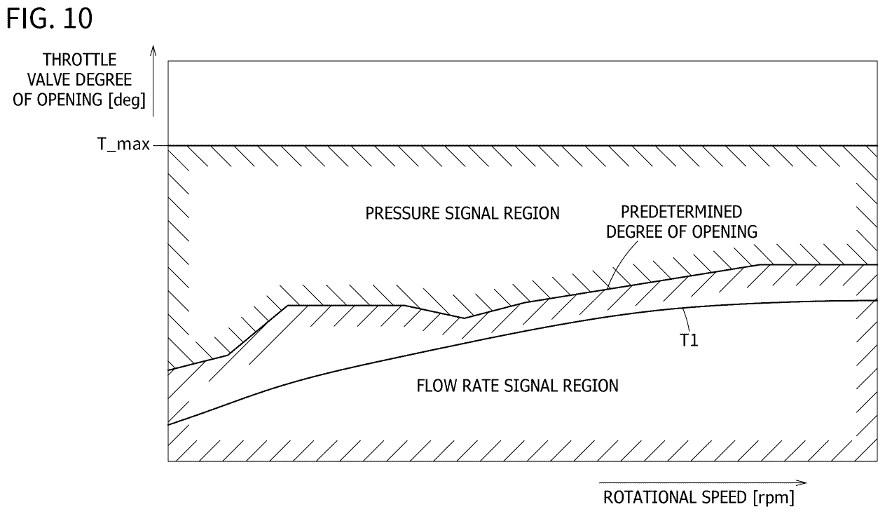

FIG. 10 is a map showing a flow rate signal region and a pressure signal region according to the second embodiment. The map in FIG. 10 is the same as the map in FIG. 3, however, the map of FIG. 10 also shows the degree of opening T1 [deg]. The degree of opening T1 [deg], as shown in FIG. 10, is set in accordance with the rotational speed of the internal combustion engine 10.

As shown in FIG. 10, the degree of opening T1 [deg] is set to a value that is smaller than the predetermined degree of opening. Therefore, in the second embodiment, the pressure signal region comes about only in the case that the throttle valve degree of opening is fully open T_max [deg].

### [Throttle Valve Degree of Opening Control]

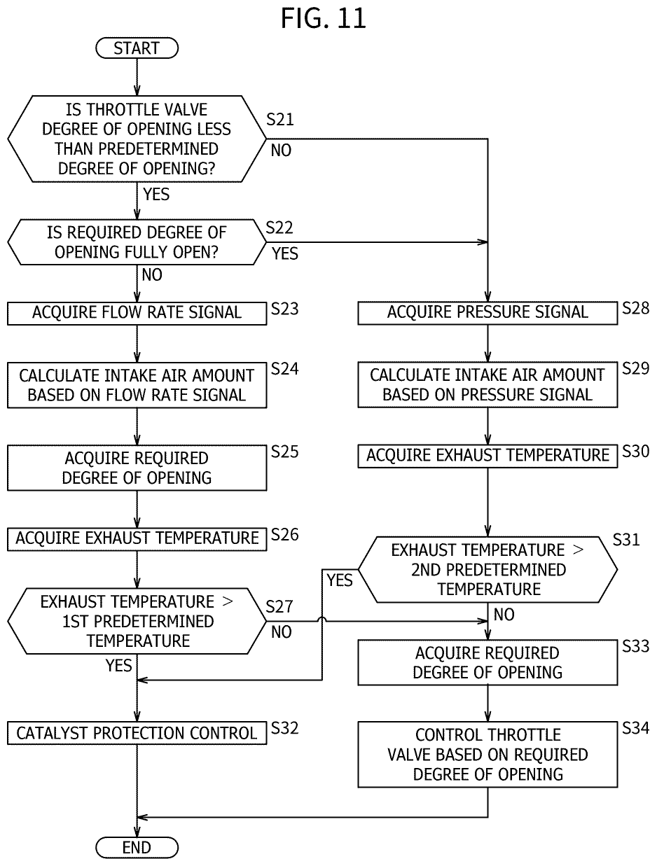

FIG. 11 is a flowchart of the throttle valve degree of opening control according to the second embodiment. In the control device 36, the throttle valve degree of opening control is executed at predetermined intervals while the internal combustion engine 10 is being driven.

In step S21, the intake air amount calculation unit 46 determines whether or not the throttle valve degree of opening is less than the predetermined degree of opening. In the case that it is determined that the throttle valve degree of opening is less than the predetermined degree of opening (step S21: YES), the process transitions to step S22.

In step S22, the required degree of opening calculation unit 52 acquires the required degree of opening. In the case that it is determined that the required degree of opening is not fully open (step S22: NO), the process transitions to step S23.

In step S23, the flow rate signal acquisition unit 42 acquires the flow rate signal from the air flow meter 24. Thereafter, the process transitions to step S24.

In step S24, the intake air amount calculation unit 46 calculates the intake air amount based on the flow rate signal. Thereafter, the process transitions to step S25.

In step S25, the required degree of opening calculation unit 52 acquires the required degree of opening. Thereafter, the process transitions to step S26.

In step S26, the exhaust temperature acquisition unit 48 acquires the exhaust temperature. Thereafter, the process transitions to step S27.

In step S27, the control unit 54 determines whether or not the exhaust temperature is greater than the first predetermined temperature.

In step S21, in the case that it is determined that the throttle valve degree of opening is greater than or equal to the predetermined degree of opening (step S21: NO), or alternatively, in step S22, in the case that it is determined that the required degree of opening is fully open (step S22: YES), the process transitions to step S28.

In step S28, the pressure signal acquisition unit 44 acquires a pressure signal from the pressure sensor 26. Thereafter, the process transitions to step S29.

In step S29, the intake air amount calculation unit 46 calculates the intake air amount based on the pressure signal. Thereafter, the process transitions to step S30.

In step S30, the exhaust temperature acquisition unit 48 acquires the exhaust temperature. Thereafter, the process transitions to step S31.

In step S31, the control unit 54 determines whether or not the exhaust temperature is greater than the second predetermined temperature.

In step S27, in the case that it is determined that the exhaust temperature is greater than the first predetermined temperature (step S27: YES), or alternatively, in step S31, in the case that it is determined that the exhaust temperature is greater than the second predetermined temperature (step S31: YES), the process transitions to step S32.

In step S32, the control unit 54 carries out the catalyst protection control. The catalyst protection control indicates the aforementioned air amount limiting control.

In step S27, in the case that it is determined that the exhaust temperature is less than or equal to the first predetermined temperature (step S27: NO), or alternatively, in step S31, in the case that it is determined that the exhaust temperature is less than or equal to the second predetermined temperature (step S31: NO), the process transitions to step S33.

In step S33, the required degree of opening calculation unit 52 acquires the required degree of opening. Thereafter, the process transitions to step S34.

In step S34, the control unit 54 controls the throttle valve 22 based on the required degree of opening.

According to the second embodiment, even in the case that the throttle valve degree of opening is less than the predetermined degree of opening and lies within the flow rate signal region, in the case that the required degree of opening is fully open, the exhaust temperature at which the catalyst protection control is initiated is set to the second predetermined temperature. There is a slight delay in the change of the throttle valve degree of opening with respect to the change in the required degree of opening. However, in the case that the required degree of opening is fully open, in a short time period, the throttle valve degree of opening becomes greater than or equal to the predetermined degree of opening, and enters into the pressure signal region. Therefore, even in the case that the throttle valve degree of opening is present in the flow rate signal region, in the case that the required degree of opening is fully open, the intake air flow rate is calculated based on the pressure signal, and the exhaust temperature at which the catalyst protection control is initiated is set to the second predetermined temperature. In accordance with this feature, it is possible to shorten the period during which the air amount restriction control is carried out, and to shorten the period during which the output of the internal combustion engine 10 is restricted. Further, it is possible to reduce the operating range in which the output of the internal combustion engine 10 is restricted.

Within the flow rate signal region, the catalyst protection control may be carried out prior to the exhaust temperature reaching the first predetermined temperature, in a manner so that the exhaust temperature does not reach the first predetermined temperature. Further, within the pressure signal region, the catalyst protection control may be carried out prior to the exhaust temperature reaching the second predetermined temperature, in a manner so that the exhaust temperature does not reach the second predetermined temperature. Furthermore, even in the case that the throttle valve degree of opening is present in the flow rate signal region, in the case that the required degree of opening is fully open, the intake air flow rate may be calculated based on the pressure signal, and the catalyst protection control may be carried out prior to the exhaust temperature reaching the second predetermined temperature, in a manner so that the exhaust temperature does not reach the second predetermined temperature.

Concerning the above-described embodiments, the following supplementary notes are further disclosed.

### Supplementary Note 1

The control device (36) for the internal combustion engine (10) according to the present disclosure includes the flow rate signal acquisition unit (42) configured to acquire from the air flow meter (24) the flow rate signal that changes in accordance with the air flow rate inside the intake pipe (14) of the internal combustion engine, the pressure signal acquisition unit (44) configured to acquire from the pressure sensor (26) the pressure signal that changes in accordance with the pressure inside the intake pipe, the intake air amount calculation unit (46) configured to calculate, based on the flow rate signal or the pressure signal, the intake air amount, which is the amount of air taken in by the internal combustion engine, the exhaust temperature acquisition unit (48) configured to acquire the exhaust temperature of the internal combustion engine, and the control unit (54) which, by adjusting the throttle valve degree of opening, carries out the catalyst protection control to limit the intake air amount in order to protect the catalyst (28), wherein, in the case that the intake air amount is calculated based on the flow rate signal, the control unit carries out the catalyst protection control based on the acquired exhaust temperature and the first predetermined temperature, and in the case that the intake air amount is calculated based on the pressure signal, the control unit carries out the catalyst protection control based on the acquired exhaust temperature and the second predetermined temperature that differs from the first predetermined temperature. In accordance with such features, it is possible to differentiate between a timing at which the catalyst protection control is started in the case that the intake air amount is calculated based on the flow rate signal, and a timing at which the catalyst protection control is started in the case that the intake air amount is calculated based on the pressure signal.

### Supplementary Note 2

In the control device for the internal combustion engine according to Supplementary Note 1, in the case that the intake air amount is calculated based on the flow rate signal, and in the case that the acquired exhaust temperature is higher than the first predetermined temperature, the catalyst protection control may be carried out, and in the case that the intake air amount is calculated based on the pressure signal, and in the case that the acquired exhaust temperature is higher than the second predetermined temperature, the catalyst protection control may be carried out.

### Supplementary Note 3

In the control device for the internal combustion engine according to Supplementary Note 1, in the case that the intake air amount is calculated based on the flow rate signal, by the catalyst protection control being carried out, the exhaust temperature may be made less than or equal to the first predetermined temperature, and in the case that the intake air amount is calculated based on the pressure signal, by the catalyst protection control being carried out, the exhaust temperature may be made less than or equal to the second predetermined temperature.

### Supplementary Note 4

In the control device for the internal combustion engine according to Supplementary Note 1 or 2, in the case that the throttle valve degree of opening is less than the predetermined degree of opening, the intake air amount may be calculated based on the flow rate signal, and in the case that the throttle valve degree of opening is greater than or equal to the predetermined degree of opening, the intake air amount may be calculated based on the pressure signal.

### Supplementary Note 5

In the control device for the internal combustion engine according to Supplementary Note 1 or 2, the second predetermined temperature may be higher than the first predetermined temperature.

### Supplementary Note 6

In the control device for the internal combustion engine according to Supplementary Note 1 or 2, there may further be provided the required degree of opening acquisition unit (50) configured to acquire the required value of the throttle valve degree of opening, wherein, in the case that the required degree of opening is fully open, the intake air amount calculation unit may calculate the air intake amount based on the pressure signal, and even in the case that the air amount is calculated based on the flow rate signal, the catalyst protection control may be carried out based on the exhaust temperature and the second predetermined temperature.

### Supplementary Note 7

The control method for the internal combustion engine includes the signal acquisition step of acquiring from the air flow meter the flow rate signal that changes in accordance with the air flow rate inside the intake pipe of the internal combustion engine, or alternatively, acquiring from the pressure sensor the pressure signal that changes in accordance with the pressure inside the intake pipe, the intake air amount calculation step of calculating, based on the flow rate signal or the pressure signal, the intake air amount, which is the amount of air taken in by the internal combustion engine, the exhaust temperature acquisition step of acquiring the exhaust temperature of the internal combustion engine, and the control step of carrying out the catalyst protection control to limit the intake air amount in order to protect the catalyst by adjusting the throttle valve degree of opening, wherein, in the case that the intake air amount is calculated based on the flow rate signal, the catalyst protection control is carried out based on the acquired exhaust temperature and the first predetermined temperature, and in the case that the intake air amount is calculated based on the pressure signal, the catalyst protection control is carried out based on the acquired exhaust temperature and the second predetermined temperature that differs from the first predetermined temperature.

### Supplementary Note 8

In the control method for the internal combustion engine according to Supplementary Note 7, in the case that the intake air amount is calculated based on the flow rate signal, and in the case that the acquired exhaust temperature is higher than the first predetermined temperature, the catalyst protection control may be carried out, and in the case that the intake air amount is calculated based on the pressure signal, and in the case that the acquired exhaust temperature is higher than the second predetermined temperature, the catalyst protection control may be carried out.

### Supplementary Note 9

In the control method for the internal combustion engine according to Supplementary Note 7, in the case that the intake air amount is calculated based on the flow rate signal, by the catalyst protection control being carried out, the exhaust temperature may be made less than or equal to the first predetermined temperature, and in the case that the intake air amount is calculated based on the pressure signal, by the catalyst protection control being carried out, the exhaust temperature may be made less than or equal to the second predetermined temperature.

### Supplementary Note 10

In the control method for the internal combustion engine according to Supplementary Note 7, in the case that the throttle valve degree of opening is less than the predetermined degree of opening, the intake air amount may be calculated based on the flow rate signal, and in the case that the throttle valve degree of opening is greater than or equal to the predetermined degree of opening, the intake air amount may be calculated based on the pressure signal.

### Supplementary Note 11

In the control method for the internal combustion engine according to Supplementary Note 7, the second predetermined temperature may be higher than the first predetermined temperature.

### Supplementary Note 12

In the control method for the internal combustion engine according to Supplementary Note 7, there may further be provided the required degree of opening acquisition step of acquiring the required degree of opening, which is the required value of the throttle valve degree of opening, wherein, in the case that the required degree of opening is fully open, the air intake amount may be calculated based on the pressure signal, and even in the case that the air amount is calculated based on the flow rate signal, the catalyst protection control may be carried out based on the exhaust temperature and the second predetermined temperature.

### Supplementary Note 13

The program of the present disclosure causes the computer to execute the control method for the internal combustion engine according to any one of Supplementary Notes 7 to 12.

### Supplementary Note 14

A computer readable non-transitory storage medium according to the present disclosure stores the program according to Supplementary Note 13.

Although the present disclosure has been described in detail, the present disclosure is not necessarily limited to the specific embodiments described above. These embodiments can be subjected to various additions, substitutions, modifications, partial deletions, and the like, within a range that does not depart from the essence and gist of the present disclosure, or alternatively, the spirit and gist of the present disclosure as derived from the contents described in the claims and their equivalents. Further, these embodiments can also be implemented in combination. For example, in the above-described embodiments, the order of the operations and the order of the processes are shown merely as examples, and the present invention is not necessarily limited to these examples. The same applies also in the case that numerical values or mathematical expressions are used in the description of the aforementioned embodiments.

The program (a computer program, computer software) according to the present embodiment may also be referred to as a computer program product. The computer program product is not limited to being a computer program that is recorded on a recording medium, but may also include a computer program that is transmitted, distributed, or downloaded via the Internet or the like.

1. A control device for an internal combustion engine, comprising one or more processors that execute computer-executable instructions stored in a memory, wherein the one or more processors execute the computer-executable instructions to cause the control device for the internal combustion engine to:
acquire from an air flow meter a flow rate signal that changes in accordance with an air flow rate inside an intake pipe of the internal combustion engine;
acquire from a pressure sensor a pressure signal that changes in accordance with a pressure inside the intake pipe;
based on the flow rate signal or the pressure signal, calculate an intake air amount, which is an amount of air taken in by the internal combustion engine;
acquire an exhaust temperature of the internal combustion engine;
by adjusting a throttle valve degree of opening, carry out a catalyst protection control to limit the intake air amount in order to protect a catalyst;
in a case that the intake air amount is calculated based on the flow rate signal, carry out the catalyst protection control based on the acquired exhaust temperature and a first predetermined temperature; and
in a case that the intake air amount is calculated based on the pressure signal, carry out the catalyst protection control based on the acquired exhaust temperature and a second predetermined temperature that differs from the first predetermined temperature.

2. The control device for the internal combustion engine according to claim 1, wherein:
in the case that the intake air amount is calculated based on the flow rate signal, and in a case that the acquired exhaust temperature is higher than the first predetermined temperature, the catalyst protection control is carried out; and
in the case that the intake air amount is calculated based on the pressure signal, and in a case that the acquired exhaust temperature is higher than the second predetermined temperature, the catalyst protection control is carried out.

3. The control device for the internal combustion engine according to claim 1, wherein:
in the case that the intake air amount is calculated based on the flow rate signal, by the catalyst protection control being carried out, the exhaust temperature is made less than or equal to the first predetermined temperature; and
in the case that the intake air amount is calculated based on the pressure signal, by the catalyst protection control being carried out, the exhaust temperature is made less than or equal to the second predetermined temperature.

4. The control device for the internal combustion engine according to claim 1, wherein:
in a case that the throttle valve degree of opening is less than a predetermined degree of opening, the intake air amount is calculated based on the flow rate signal; and
in a case that the throttle valve degree of opening is greater than or equal to the predetermined degree of opening, the intake air amount is calculated based on the pressure signal.

5. The control device for the internal combustion engine according to claim 1, wherein the second predetermined temperature is higher than the first predetermined temperature.

6. The control device for the internal combustion engine according to claim 1, wherein:
a required degree of opening, which is a required value of the throttle valve degree of opening, is acquired;
in the case that the required degree of opening is fully open, the air intake amount is calculated based on the pressure signal, and even in the case that the air amount is calculated based on the flow rate signal, the catalyst protection control is carried out based on the exhaust temperature and the second predetermined temperature.

7. A control method for an internal combustion engine, the method executed by one or more processors and comprising:
acquiring from an air flow meter a flow rate signal that changes in accordance with an air flow rate inside an intake pipe of the internal combustion engine, or alternatively, acquiring from a pressure sensor a pressure signal that changes in accordance with a pressure inside the intake pipe;
calculating, based on the flow rate signal or the pressure signal, an intake air amount, which is an amount of air taken in by the internal combustion engine;
acquiring an exhaust temperature of the internal combustion engine; and
carrying out a catalyst protection control to limit the intake air amount in order to protect a catalyst by adjusting a throttle valve degree of opening;
wherein, in a case that the intake air amount is calculated based on the flow rate signal, the catalyst protection control is carried out based on the acquired exhaust temperature and a first predetermined temperature; and
in a case that the intake air amount is calculated based on the pressure signal, the catalyst protection control is carried out based on the acquired exhaust temperature and a second predetermined temperature that differs from the first predetermined temperature.

8. The control method for the internal combustion engine according to claim 7, wherein:
in the case that the intake air amount is calculated based on the flow rate signal, and in a case that the acquired exhaust temperature is higher than the first predetermined temperature, the catalyst protection control is carried out; and
in the case that the intake air amount is calculated based on the pressure signal, and in a case that the acquired exhaust temperature is higher than the second predetermined temperature, the catalyst protection control is carried out.

9. The control method for the internal combustion engine according to claim 7, wherein:
in the case that the intake air amount is calculated based on the flow rate signal, by the catalyst protection control being carried out, the exhaust temperature is made less than or equal to the first predetermined temperature; and
in the case that the intake air amount is calculated based on the pressure signal, by the catalyst protection control being carried out, the exhaust temperature is made less than or equal to the second predetermined temperature.

10. The control method for the internal combustion engine according to claim 7, wherein:
in a case that the throttle valve degree of opening is less than a predetermined degree of opening, the intake air amount is calculated based on the flow rate signal; and
in a case that the throttle valve degree of opening is greater than or equal to the predetermined degree of opening, the intake air amount is calculated based on the pressure signal.

11. The control method for the internal combustion engine according to claim 7, wherein the second predetermined temperature is higher than the first predetermined temperature.

12. The control method for the internal combustion engine according to claim 7, further comprising:
acquiring a required degree of opening, which is a required value of the throttle valve degree of opening;
wherein, in the case that the required degree of opening is fully open, the air intake amount is calculated based on the pressure signal, and even in the case that the air amount is calculated based on the flow rate signal, the catalyst protection control is carried out based on the exhaust temperature and the second predetermined temperature.

13. A computer readable non-transitory storage medium in which a program that causes a computer to execute the control method for the internal combustion engine according to claim 7 is stored.
